(19) United States
(12) Patent Application Publication
(10) Pub. No.: US 2005/0089205 A1
(43) Pub. Date: Apr. 28, 2005

(54) Systems and methods for viewing an abnormality in different kinds of images

(76) Inventors: Ajay Kapur, Clifton Park, NY (US); Boris Yamrom, Bronx, NY (US); Oliver Richard Astley, Clifton Park, NY (US)

Correspondence Address: GENERAL ELECTRIC COMPANY (PCPI);C/O FLETCHER YODER, P. O. BOX 692289, HOUSTON, TX, 77269-2289, US

(21) Appl. No.: 10/692,450

(22) Filed: Oct. 23, 2003

(51) Int. Cl. G06K 9/00

(52) U.S. Cl. 382/128

(57) ABSTRACT

A method for viewing an abnormality in different kinds of images is described. The method includes scanning an object using a first imaging system to obtain at least a first image of the object, determining coordinates of a region of interest (ROI) visible on the first image, wherein the ROI includes the abnormality, and using the coordinates of the ROI to scan the object with a second imaging system.

### STATEMENT REGARDING FEDERALLY SPONSORED RESEARCH & DEVELOPMENT

The government may have rights in this invention pursuant to project number MDA905-00-1-0041 funded by the Office of Naval Research.

### BACKGROUND OF THE INVENTION

This invention relates generally to imaging and more particularly to systems and methods for viewing an abnormality in different kinds of images.

In at least some known imaging systems, a radiation source projects a cone-shaped beam which passes through a subject, such as a patient, being imaged, and impinges upon a rectangular array of radiation detectors. In at least one known tomosynthesis system, the radiation source rotates with a gantry around a pivot point, and views of the subject may be acquired for different projection angles.

In other known medical imaging systems, ultrasound diagnostic equipment is used to view organs of the subject. Conventional ultrasound diagnostic equipment typically includes an ultrasound probe for transmitting ultrasound signals into the subject and receiving reflected ultrasound signals therefrom. The reflected ultrasound signals received by the ultrasound probe are processed and an image of an object, such as a breast, of the subject under examination is formed.

Projection mammography performed using the radiation source and the detector may suffer from certain limitations, such as structured noise from overlying anatomical structures that are in the path of an X-ray beam. Accordingly, during inspection of the mammograms, when radiologists identify suspicious regions, they may request follow-up examinations of the breast with ultrasound and/or diagnostic x-rays. More specifically, women with suspected cysts are usually requested to have a follow-up ultrasound exam.

Follow-up ultrasound examinations, however, are not usually conducted on the subject in the same geometry and are thus difficult to spatially co-relate with the mammograms. Moreover, an ultrasound examination is typically performed by free-hand scanning, which is inherently dependent on the skills of an operator performing the scan, making them not very reproducible. Furthermore, generally, the ultrasound examination is performed separately from the mammogram and as such may raise scheduling, administrative, reimbursement, and/or health plan issues. Thus, there is some uncertainty as to whether the follow-up ultrasound examination locates and characterizes the same region as characterized by the mammograms.

Registration of images generated using at least some known X-ray and ultrasound imaging modalities is done by providing fiducial marks in an environment that becomes visible in both the X-ray and ultrasound imaging modalities and that have known coordinates in some fixed coordinate system. However, registration may be challenging since an X-ray examination is typically accomplished with the patient in an upright orientation and the breast compressed cranio-caudally, laterally or latero-medial-obliquely, while an ultrasound examination is typically performed by scanning the breast with the patient in a supine orientation. Moreover, the ultrasound examination is performed by scanning the breast from the nipple to the chest wall radially or anti-radially and is performed at a different state of compression than a state of compression in which the X-ray examination is performed.

### BRIEF DESCRIPTION OF THE INVENTION

In one aspect, a method for viewing an abnormality in different kinds of images is provided. The method includes scanning an object using a first imaging system to obtain at least a first image of the object, determining coordinates of a region of interest (ROI) visible on the first image, wherein the ROI includes the abnormality, and using the coordinates of the ROI to scan the object with a second imaging system.

In another aspect, a system for viewing an abnormality in different kinds of images is provided. The system includes an X-ray imaging system configured to scan an object to obtain at least one X-ray image of the object, and a controller. The controller is configured to determine coordinates of an ROI visible on the first image, the ROI including the abnormality, and utilize the coordinates of the ROI to scan the object with an ultrasound imaging system.

In yet another aspect, a method for viewing an abnormality in different kinds of images is provided. The method includes registering 3-dimensional (3D) data relative to 2-dimensional (2D) data, wherein the 3D data is obtained using an imaging system that is different than an imaging system used to obtain the 2D data.

In still another aspect, a method for viewing an abnormality in different kinds of images is provided. The method includes scanning an object using an X-ray imaging system to obtain at least one X-ray image of the object, determining coordinates of an ROI on the X-ray image, wherein the ROI includes the abnormality, instructing an ultrasound probe mover to move a probe to the co-ordinates to scan a specific region of the object, wherein the specific region is defined by the coordinates, and instructing an ultrasound imaging system to scan the specific region of the object to obtain at least one ultrasound image.

In another aspect, a system for viewing an abnormality in different kinds of images is provided. The system includes an X-ray imaging system configured to scan an object to obtain at least one X-ray image of the object, and a controller. The controller is configured to determine coordinates of an ROI visible on the X-ray image, the ROI including the abnormality, utilize the coordinates of the ROI to scan the object with an ultrasound imaging system, and register 2D data from which the X-ray image is generated with 3D data obtained by scanning the object with the ultrasound imaging system.

### BRIEF DESCRIPTION OF THE DRAWINGS

FIG. 1 is a pictorial view of an imaging system.

FIG. 2 is an enlarged pictorial view of a tomosynthesis imaging system used with the imaging system of FIG. 1.

FIG. 3 is a side view of a portion of a compression paddle used with the imaging system of FIG. 1.

FIG. 4 is a top view of a probe mover assembly used with the imaging system of FIG. 1.

FIG. 5 is a flow diagram of an exemplary method for generating an image of an object.

FIG. 6 is another pictorial view of the imaging system of FIG. 1.

FIG. 7 is a pictorial view of a compression paddle, an interface, and an ultrasound imaging system used with the imaging system of FIG. 1.

FIG. 8 is a side view of a portion of the ultrasound imaging system shown in FIG. 7.

FIG. 9 is an image illustrating exemplary effects of refractive corrections.

FIG. 10 is the same image illustrated in FIG. 9 without the refractive corrections.

FIG. 11 is an embodiment of a system for viewing an abnormality in different kinds of images.

FIG. 12 shows an XYZ and an X′Y′Z′ coordinate system used to illustrate an exemplary method for viewing an abnormality in different kinds of images.

FIG. 13 shows an exemplary X-ray image acquired using the imaging system of FIG. 1.

FIG. 14 shows exemplary X-ray images acquired using the imaging system of FIG. 1.

FIG. 15 shows ultrasound images to illustrate an embodiment of a method for viewing an abnormality in different kinds of images.

### DETAILED DESCRIPTION OF THE INVENTION

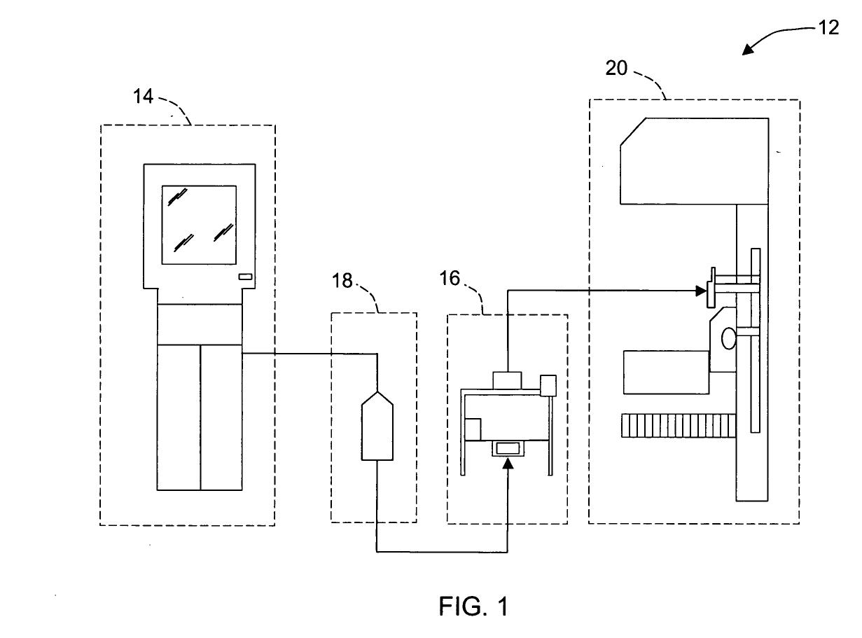

FIG. 1 is a pictorial view of a medical imaging system 12. In the exemplary embodiment, imaging system 12 includes an ultrasound imaging system 14, a probe mover assembly 16, an ultrasound probe 18, and at least one of an X-ray imaging system and a tomosynthesis imaging system 20. Ultrasound imaging system 14, probe mover assembly 16, ultrasound probe 18, and tomosynthesis imaging system 20 are operationally integrated in imaging system 12. In another embodiment, ultrasound imaging system 14, probe mover assembly 16, ultrasound probe 18, and tomosynthesis imaging system 20 are physically integrated in a unitary imaging system 12.

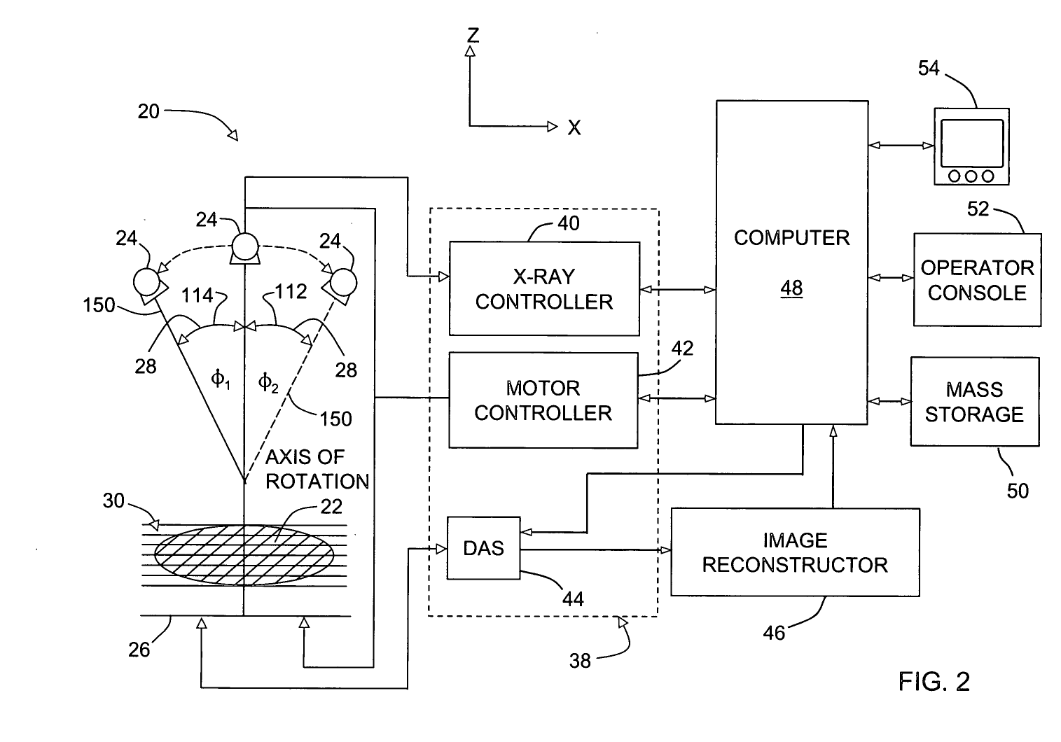

FIG. 2 is a pictorial view of tomosynthesis imaging system 20. In the exemplary embodiment, tomosynthesis imaging system 20 is used to generate a three-dimensional dataset representative of an imaged object 22, such as a patient's breast. System 20 includes a radiation source 24, such as an X-ray source, and at least one detector array 26 for collecting views from a plurality of projection angles 28. Specifically, system 20 includes a radiation source 24 which projects a cone-shaped beam of X-rays which pass through object 22 and impinge on detector array 26. The views obtained at each angle 28 may be used to reconstruct a plurality of slices, i.e., images representative of structures located in planes 30 which are parallel to detector 26. Detector array 26 is fabricated in a panel configuration having a plurality of pixels (not shown) arranged in rows and columns, such that an image is generated for an entire object 22 of interest, such as a breast.

Each pixel includes a photosensor, such as a photodiode (not shown), that is coupled via a switching transistor (not shown) to two separate address lines (not shown). In one embodiment, the two lines are a scan line and a data line. The radiation incident on a scintillator material and the pixel photosensors measure, by way of change in the charge across the diode, an amount of light generated by X-ray interaction with the scintillator. More specifically, each pixel produces an electronic signal that represents an intensity, after attenuation by object 22, of an X-ray beam impinging on detector array 26. In one embodiment, detector array 26 is approximately 19 centimeters (cm) by 23 cm and is configured to produce views for an entire object 22 of interest, e.g., a breast. Alternatively, detector array 26 is variably sized depending on the intended use. Additionally, a size of the individual pixels on detector array 26 is selected based on the intended use of detector array 26.

In the exemplary embodiment, the reconstructed three-dimensional dataset is not necessarily arranged in slices corresponding to planes that are parallel to detector 26, but in a more general fashion. In another embodiment, the reconstructed dataset consists only of a single two-dimensional (2D) image, or one-dimensional function. In a further embodiment, detector 26 is a shape other than planar.

In the exemplary embodiment, radiation source 24 is moveable relative to object 22. More specifically, radiation source 24 is translatable such that the projection angle 28 of the imaged volume is altered. Radiation source 24 is translatable such that projection angle 28 may be any acute or oblique projection angle.

The operation of radiation source 24 is governed by a control mechanism 38 of imaging system 20. Control mechanism 38 includes a radiation controller 40 that provides power and timing signals to radiation source 24, and a motor controller 42 that controls a respective translation speed and position of radiation source 24 and detector array 26. A data acquisition system (DAS) 44 in control mechanism 38 samples digital data from detector 26 for subsequent processing. An image reconstructor 46 receives sampled and digital projection dataset from DAS 44 and performs a high-speed image reconstruction. The reconstructed three-dimensional dataset, representative of imaged object 22, is applied as an input to a computer 48 which stores the three-dimensional dataset in a mass storage device 50. Image reconstructor 46 is programmed to perform functions described herein, and, as used herein, the term image reconstructor refers to computers, processors, microcontrollers, microcomputers, programmable logic controllers, application specific integrated circuits, and other programmable circuits. Moreover, computer 48 is programmed to perform functions described herein, and as used herein, the term computer is not limited to just those integrated circuits referred to in the art as computers, but broadly refers to controllers, processors, microcontrollers, microcomputers, programmable logic controllers, application specific integrated circuits, and other programmable circuits, and these terms are used interchangeably herein

Computer 48 also receives commands and scanning parameters from an operator via a console 52 having an input device. A display 54, such as a cathode ray tube and a liquid crystal display (LCD), allows the operator to observe the reconstructed three-dimensional dataset and other data from computer 48. The operator supplied commands and parameters are used by computer 48 to provide control signals and information to DAS 44, motor controller 42, and radiation controller 40.

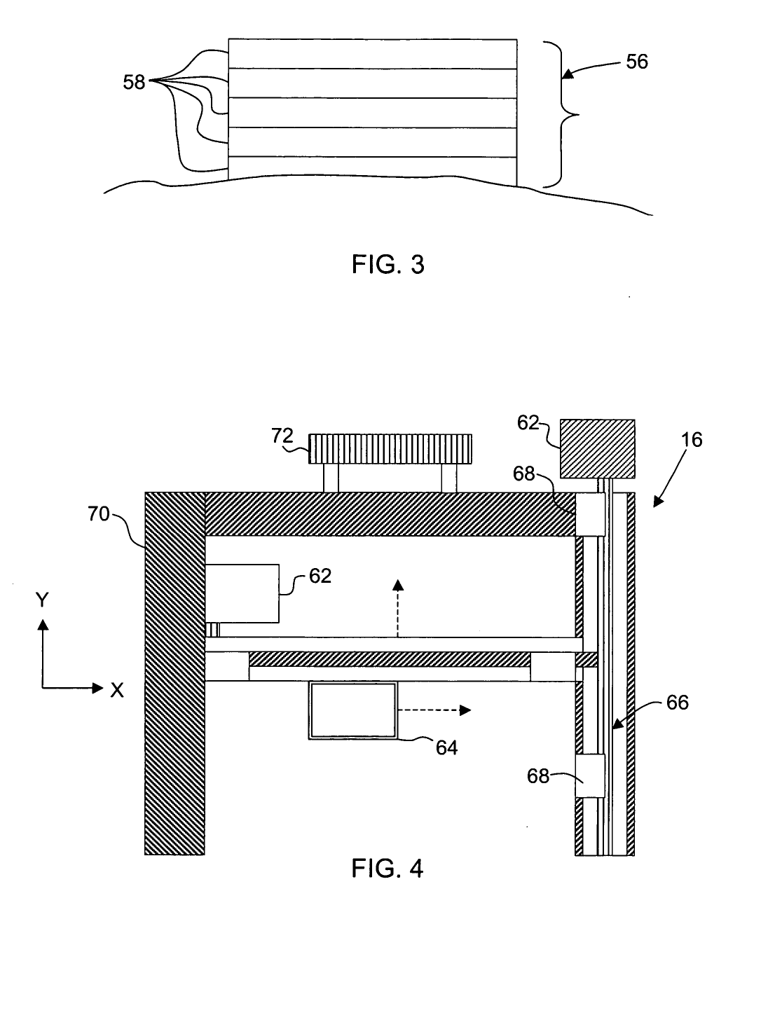

Imaging system 20 also includes a compression paddle 56, shown in FIG. 3, that is positioned adjacent probe mover assembly 16 such that probe mover assembly 16 and compression paddle 56 are mechanically aligned. Further, an ultrasound dataset, i.e. a second three-dimensional dataset, obtained with probe mover assembly 16 is co-registered with an X-ray dataset, i.e. a first three-dimensional dataset, obtained through compression paddle 56 by mechanical design. In one embodiment, ultrasound probe 18 is operationally coupled with probe mover assembly 16 such that ultrasound probe 18 emits an ultrasound output signal through compression paddle 56 and a breast, which is at least partially reflected when an interface, such as a cyst, is encountered within the breast. In another embodiment, ultrasound probe 18 is a 2D array of capacitative micro-machined ultrasonic transducers that are operationally coupled to compression paddle 56, and probe mover assembly 16 is not used.

FIG. 3 is a side view of compression paddle 56. In one embodiment, compression paddle 56 is acoustically transparent (sonolucent) and X-ray transparent (radiolucent), and fabricated from a composite of plastic materials, such as, but not limited to materials listed in Table 1 below, such that an attenuation coefficient of compression paddle 56 is less than approximately 5.0 decibels per centimeter when imaging system 12 is operating at approximately 10 megahertz, thereby minimizing ultrasonic reverberations and attenuation through compression paddle 56. In another embodiment, compression paddle 56 is fabricated using a single composite material. In a further embodiment, compression paddle 56 is fabricated using a single non-composite material. In yet another embodiment, compression paddle 56 is approximately 2-3 millimeters (mm) in thickness and may include a plurality of layers 58. Layers 58 are fabricated using a plurality of rigid composite materials, such as, but not limited to polycarbonates, polymethylpentenes, and polystyrenes. Compression paddle 56 is designed using a plurality of design parameters shown in Table 1. Compression paddle 56 design parameters include, but are not limited to, X-ray attenuation, atomic number, optical transmission, tensile modulus, speed of sound, density, an elongation, Poisson ratio, acoustic impedance, and ultrasonic attenuation.

TABLE 1

| | | Acoustic | | | | | |
|---|---|---|---|---|---|---|---|
| | | | | | Attenuation | X-Ray | |
| | | Density | speed | | @ 5 MHz | Attenuation | Color Change |
| Material | Acronym | g/cm³ | mm/μs | impedance | dB/cm | % in 3 mm | 10 = none |
| Polymethylpentene | PMP, TP | 0.83 | 2.22 | 1.84 | 4.6 | 9.4 | 8 |
| Polycarbonate | PC | 1.18 | 2.27 | 2.68 | 23.2 | 14.8 | 5 |
| Polystyrene | PS | 1.05 | 2.4 | 2.52 | 1.8 | 14.7 | 9 |
| Polyethylene Terephthalate | PET | 1.37 | 2.54 | 3.48 | 5 | 15.6 | 2 |
| Epoxy | | 1.21 | 2.8 | 3.39 | 6 | 52.2 | 8 |
| Polysulfone | PSF | 1.24 | 2.24 | 2.78 | 10.6 | 56.9 | 5 |
| Polyethylene | PE | 0.91 | 1.95 | 1.77 | 2.4 | 10.7 | 9 |
| (low density) | | | | | | | |
| Polymethylmethacrylate | PMMA | 1.19 | 2.75 | 3.27 | 6.4 | 14.8 | 5 |
| Polypropylene | PP | 0.88 | 2.74 | 2.41 | 5.1 | 10.7 | 9 |
| Polyvinyl Chloride | PVC | 1.15 | 2.33 | 2.68 | 12.8 | 64.4 | 0 |
| Silicone Rubber | SR | 1.05 | 1.05 | 1.10 | 24 | 37.9 | 10 |
| Styrene Butadiene Rubber | SBR | 1.02 | 1.92 | 1.96 | 24.3 | 20.1 | 2 |

| | | | Mechanical | | |
|---|---|---|---|---|---|
| | | Optical | Tensile | | |
| | | Transmission | Modulus | Elongation | Poisson |
| Material | Acronym | % | (GPA) | % | Ratio |
| Polymethylpentene | PMP, TP | 80 | 1.5 | 17 | 0.33 |
| Polycarbonate | PC | 90 | 2.1 | 40 | 0.33 |
| Polystyrene | PS | 90 | 2.38 | 2 | 0.33 |
| Polyethylene Terephthalate | PET | 100 | 3.2 | 5 | 0.33 |
| Epoxy | | 80 | 14.7 | 5 | 0.33 |
| Polysulfone | PSF | 80 | 2.6 | 35 | 0.33 |
| Polyethylene | PE | 10 | 1.05 | 10 | 0.33 |
| (low density) | | | | | |
| Polymethylmethacrylate | PMMA | 92 | 3.1 | 2 | 0.33 |
| Polypropylene | PP | 10 | 1.05 | 10 | 0.33 |
| Polyvinyl Chloride | PVC | 85 | 0.004 | 440 | 0.33 |
| Silicone Rubber | SR | 25 | 0.003 | 200 | 0.50 |
| Styrene Butadiene Rubber | SBR | 25 | 0.003 | 200 | 0.50 |

Fabricating compression paddle 56 includes using a plurality of composite layers 58, facilitates an effective X-ray attenuation coefficient and a point spread function that is similar to that obtained through a typical mammographic compression paddle. Additionally, an optical transmission greater than 80%, a low ultrasonic attenuation (less than 3 dB) at ultrasound probe frequencies up to approximately 14 megahertz (MHz) may be achieved using composite layers 58. Further, composite layers 58 facilitate a maximum intensity of interface reflections within 2% of a maximum beam intensity, less than 1 cm deflection from the horizontal over a 19×23 cm² area exposed to a total compression force of 20 daN, and a mechanical rigidity and a plurality of radiation resistance properties over time similar to polycarbonate.

FIG. 4 is a top view of probe mover assembly 16. In one embodiment, probe mover assembly 16 is removably coupled to compression paddle 56 and may be de-coupled from compression paddle 56, such that probe mover assembly 16 may be positioned independently above compression paddle 56. Probe mover assembly 16 includes a plurality of stepper motors 62, a position encoder (not shown) and a plurality of limit switch driven carriages (not shown), which includes at least one carriage which mounts ultrasound probe 18 (shown in FIG. 1) through a receptacle 64 to enable variable vertical positioning capabilities of compression paddle 56. In one embodiment, ultrasound probe 18 descends vertically in a z direction until contact is made with compression paddle 56. Stepper motors 62 drive ultrasound probe 18 along carriages 66 in fine increments in x and y directions using a variable speed determined by a user. Limit switches 68, along with backlash control nuts (not shown), facilitate preventing ultrasound probe 18 from moving beyond a pre-determined mechanical design of probe mover assembly 16 limits. Ultrasound probe 18 is mounted on a U-shaped plate 70 that is attached to a receptacle 72. In one embodiment, U-shaped plate 70 attaches to a plurality of guide rails (not shown) on the X-ray imaging system or tomosynthesis imaging system 20 through a separate assembly (not shown). Dimensions of probe mover assembly 16 in the x and y directions are variably selected based on a desired range of ultrasound probe 18 motion compared to the dimensions of compression paddle 56. In the z direction the dimensions are limited by a vertical clearance between radiation source 24 housing above probe mover assembly 16 and compression paddle 56 below it.

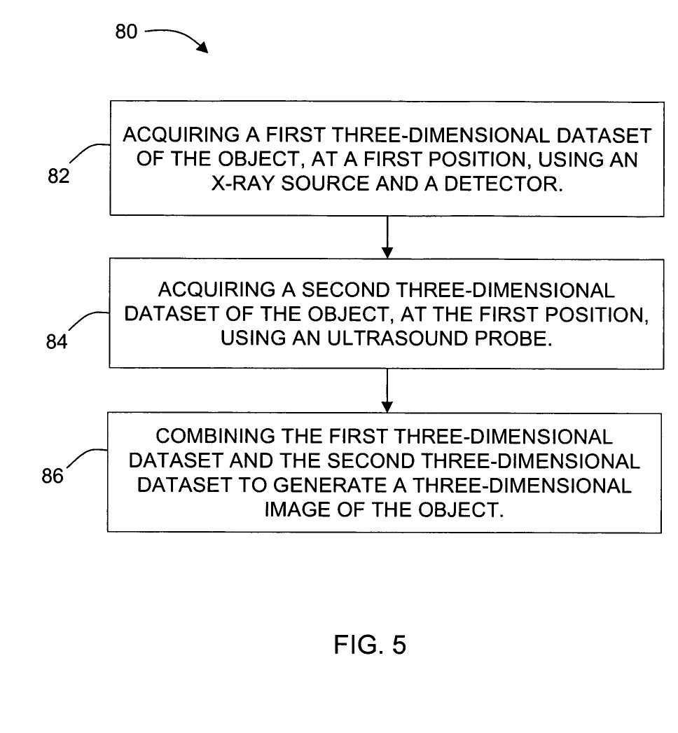

FIG. 5 is a flow diagram of an exemplary method 80 for generating an image of an object 22 of interest. Method 80 includes acquiring 82 a first three-dimensional dataset of object 22, at a first position, using X-ray source 24 and detector 26, acquiring 84 a second three-dimensional dataset of object 22, at the first position, using ultrasound probe 18, and combining 86 the first three-dimensional dataset and the second three-dimensional dataset to generate a three-dimensional image of object 22.

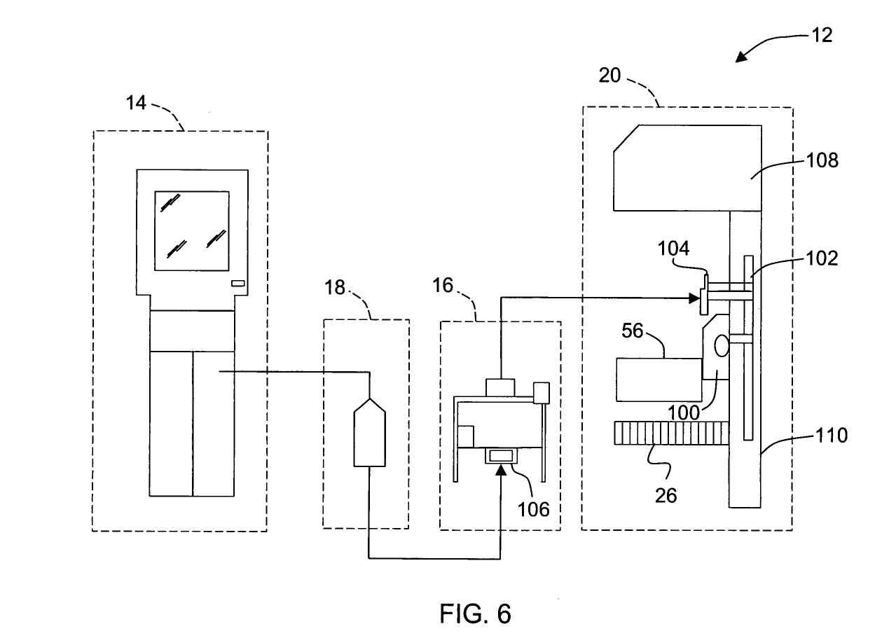

FIG. 6 a pictorial view of imaging system 12. In use, and referring to FIG. 6, compression paddle 56 is installed in tomosynthesis imaging system 20 through a compression paddle receptacle 100. In one embodiment, probe mover assembly 16 is attached to a receptacle (not shown) on a plurality of guide rails (not shown) on an X-ray positioner 102, above a compression paddle receptacle (not shown) through an attachment 104. In another embodiment, probe mover assembly 16 is attached using a plurality of side handrails (not shown) on tomosynthesis imaging system 20. Ultrasound probe 18 is connected to ultrasound imaging system 14 on one end, and interfaces with probe mover assembly 16 through a probe receptacle 106. The patient is placed adjacent tomosynthesis imaging system 20 such that the breast of the patient is positioned between compression paddle 56 and detector 26.

Ultrasound probe 18 and probe mover assembly 16 geometry is calibrated with respect to compression paddle 56. In one embodiment, calibrating ultrasound probe 18 includes ensuring that ultrasound probe 18 is installed into probe mover receptacle 104, and probe mover assembly 16 is attached to tomosynthesis imaging system 20 through compression paddle receptacle 100. Calibrating imaging system 12 facilitates ensuring that the transformation operations between co-ordinate systems is validated. A correct beam-forming code environment is installed on ultrasound imaging system 14 to facilitate correcting refractive effects through compression paddle 56. Optimal parameters are then determined based on a prior knowledge of the patient or previous X-ray or ultrasound examinations.

The patient is positioned in at least one of a cranio-caudal, medial-lateral, and an oblique position, such that the breast is positioned between compression paddle 56 and detector 26. In one embodiment, breast 23 is slightly covered with an acoustic couplant, such as, but not limited to, mineral oil. Compression paddle 56 is then used to compress the breast to an appropriate thickness using at least one of a manual control on receptacle 100 and an automatic control for receptacle 100.

An X-ray examination is then taken with tomosynthesis imaging system 20 operating in at least one of a standard 2D and a tomosynthesis mode. In the tomosynthesis mode, an X-ray tube housing 108 is modified to enable rotational capabilities about an axis vertically above detector 26 independent of a positioner 110. In one embodiment, the patient and detector 26 are fixed, and tube housing 108 rotates.

Views of the breast are then acquired from at least two projection angles 28 (shown in FIG. 2) to generate a projection dataset of the volume of interest. The plurality of views represent the tomosynthesis projection dataset. The collected projection dataset is then utilized to generate a first three-dimensional dataset, i.e., a plurality of slices for the scanned breast, that is representative of the three-dimensional radiographic representation of imaged breast 23. After enabling radiation source 24 such that the radiation beam is emitted at a first projection angle 112 (shown in FIG. 2), a view is collected using detector array 26. Projection angle 28 of system 20 is then altered by translating the position of source 24 such that central axis 150 (shown in FIG. 2) of the radiation beam is altered to a second projection angle 114 (shown in FIG. 2) and such that a position of detector array 26 is altered to facilitate breast 23 remaining within the field of view of system 20. Radiation source 24 is again enabled and a view is collected for second projection angle 114. The same procedure is then repeated for any number of subsequent projection angles 28.

In one embodiment, a plurality of views of the breast are acquired using radiation source 24 and detector array 26 at a plurality of angles 28 to generate a projection dataset of the volume of interest. In another embodiment, a single view of the breast is acquired using radiation source 24 and detector array 26 at an angle 28 to generate a projection dataset of the volume of interest. The collected projection dataset is then utilized to generate at least one of a 2D dataset and a first 3-dimensional (3D) dataset for the scanned breast. The resultant data are stored in a designated directory on computer 48 (shown in FIG. 2). If tomosynthesis scans are taken, a gantry of tomosynthesis imaging system 20 should be returned to its vertical position.

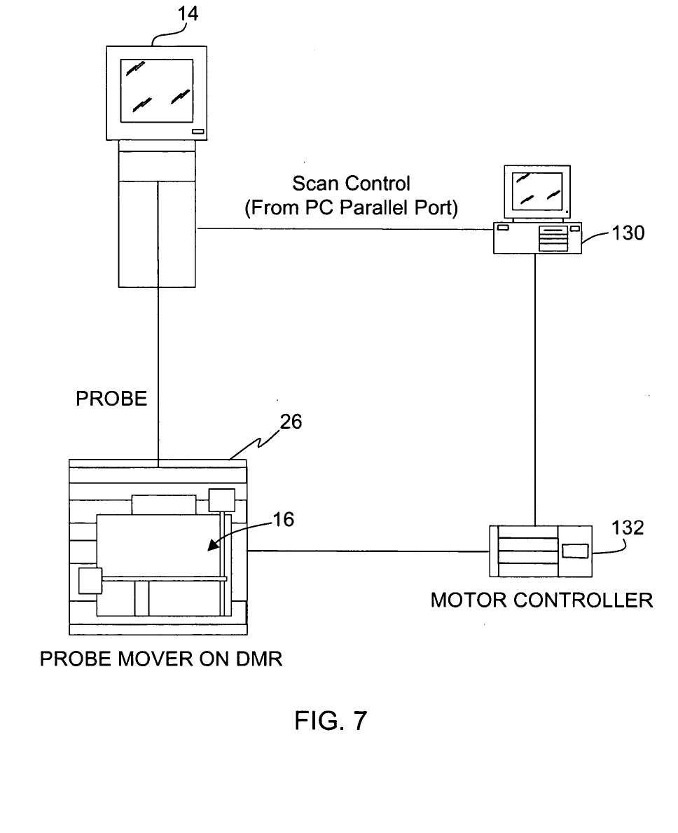

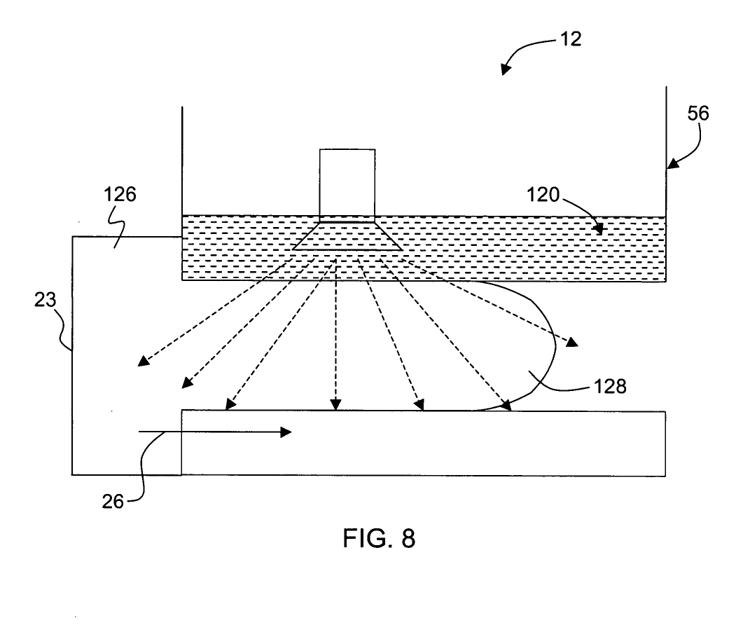

FIG. 7 is a pictorial view of compression paddle 56 and an interface between ultrasound imaging system 14 and tomosynthesis imaging system 20. FIG. 8 is a side view of a portion of imaging system 12. In the exemplary embodiment, compression paddle 56 is filled with acoustic coupling gel 120 to approximately 2 mm height above compression paddle 56. In another embodiment, an acoustic sheath (not shown) is positioned on compression paddle 56. Probe mover assembly 16 is attached to tomosynthesis imaging system 20 gantry (not shown) through attachment 104 (shown in FIG. 6) such that a probe mover assembly plane is parallel to a plane of compression paddle 56. In one embodiment, ultrasound probe 18 is lowered until the acoustic sheath is contacted. In another embodiment, ultrasound probe 18 is lowered until partially immersed in coupling gel 120. Height of ultrasound probe 18 is adjusted through receptacle 106 (shown in FIG. 6).

Ultrasound probe 18, vertically mounted above compression paddle 56, is electro-mechanically scanned over an entire breast 23 including chest wall 126 and nipple regions 128, to generate a second 3D dataset of breast 23. In one embodiment, a computer 130 drives a stepper motor controller 132 to scan breast 23 in a rastor-like fashion. In another embodiment, computer 48 (shown in FIG. 2) drives a controller 132 to scan breast 23 in a rastor-like fashion. Computer 130 is programmed to perform functions described herein, and as used herein, the term computer is not limited to just those integrated circuits referred to in the art as computers, but broadly refers to controllers, processors, microcontrollers, microcomputers, programmable logic controllers, application specific integrated circuits, and other programmable circuits, and these terms are used interchangeably herein. Ultrasound system 14 with probe 18 includes electronic beam steering and elevation focusing capabilities. In one embodiment real time ultrasound data may be viewed on a monitor of ultrasound imaging system 14. In another embodiment, ultrasound data may be viewed on any display, such as but not limited to display 54 (shown in FIG. 2). In yet another alternative embodiment, ultrasound data and X-ray data is viewed offline on computer 130, which can be a stand-alone computer. In still another alternative embodiment, ultrasound data and X-ray data is viewed on display 54 immediately after an examination of the patient. Probe mover assembly 16 is removed from tomosynthesis imaging 20, and compression paddle 56 is repositioned to release the patient.

As shown in FIG. 8, electronic beam steering enables chest wall 126 and nipple regions 128 to be imaged by looking, for example, at nipple regions 128. If ultrasound probe 18 is directly over nipple regions 128, the air gaps between compressed breast 23 and compression paddle 56 would not let the acoustic energy be transferred to nipple region 128. However with the steered beams shown entering from the left in FIG. 8, the acoustic energy is efficiently transferred, thereby reducing the need to place conforming gel pads to allow nipple regions 128 to be imaged. Further beam steering may be controlled such that acoustic shadowing due to structures such as Cooper's ligaments may be minimized by steering the beam at a number of angles and then compounding the data sets.

In one embodiment, the co-ordinate system of the first dataset is transformed into that of the second dataset, thereby allowing the datasets to be registered by hardware design and registration corrected for intermittent patient motion using imaged based registration methods. Alternatively, the co-ordinate system of the second dataset is transformed into that of the first dataset. Since the first 3D dataset and the second 3D dataset are acquired in the same physical configuration of breast 23, the images may be registered directly from the mechanical registration information. Specifically, the images may be registered directly on a point by point basis throughout breast 23's anatomy, thereby eliminating ambiguities associated with registration of 3D ultrasound images with 2D X-ray images. Alternately, the physics of the individual imaging modalities may be used to enhance the registration of the two images. Differences in spatial resolution in the two modalities, and in propagation characteristics may be taken into account to identify small positioning differences in the two images. Registration is then based on corrected positions in the 3D data sets. Matching regions of interest on either image dataset may then be simultaneously viewed in a plurality of ways, thereby enhancing qualitative visualization and quantitative characterization of enclosed objects or local regions.

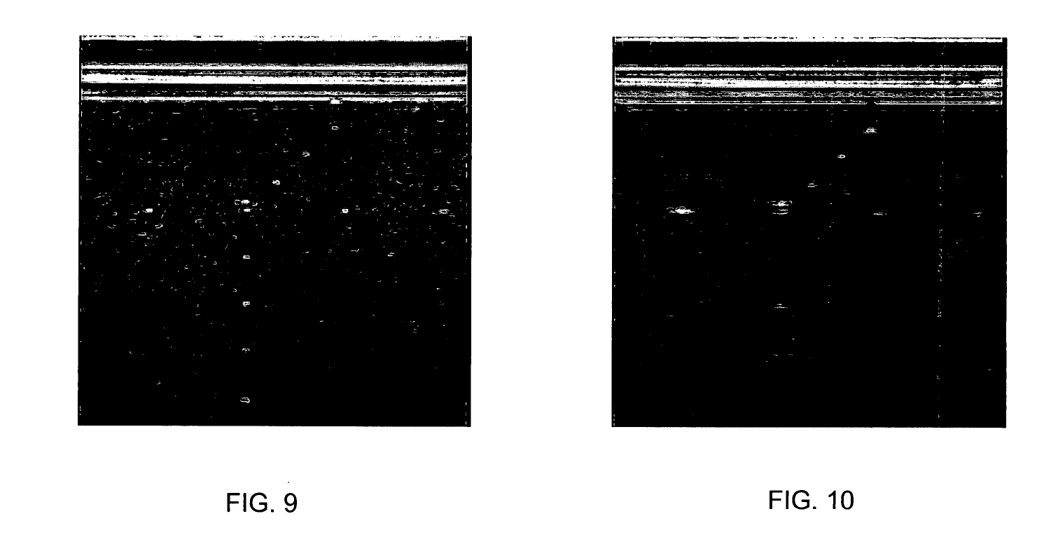

FIG. 9 is an image illustrating exemplary effects of refractive corrections at 12 MHz. FIG. 10 is the same image illustrated in FIG. 9 without the refractive corrections. In one embodiment, refractive corrections from compression paddle 56 are in built into the beam forming process as shown in FIGS. 9 and 10. The diffuse appearance of the wires is corrected for with the refraction corrections for a 3 mm plastic material. In one embodiment, ultrasound probe 18 includes at least one of an active matrix linear transducer and a phased array transducer including elevation focusing and beam steering capabilities. Because ultrasound probe 18 includes an active matrix linear transducer or a phased array transducer, the inherent spatial resolution is maintained over a much greater depth than with standard probes. Further, elevation focusing and carefully chosen compression paddle plastic materials, that enable the use of high frequency probes, high spatial resolution of the order of 250 microns for the ultrasound images is obtained with this system as validated on phantom and clinical images.

In one embodiment, a computer software program, installed on ultrasound imaging system 14, is used to drive ultrasound probe 18 in a pre-determined trajectory on compression paddle 56. The program also communicates with stepper controller 132 and the ultrasound system 14 to trigger the image and data acquisition and storage. In another embodiment, a computer software program, installed on tomosynthesis imaging system 20, is used to drive ultrasound probe 18 in a pre-determined trajectory on compression paddle 56. The program facilitates increasing ultrasound probe 18 positioning accuracy within approximately ±100 microns.

Additionally, imaging system 12 facilitates de-coupling the image acquisition process such that the hardware utilized for one examination, i.e., X-ray source 24 and detector 26, minimally affects the image quality of the other image generated using ultrasound probe 18. Further, system 12 facilitates a reduction in structured noise, cyst versus solid mass differentiation, and full 3D visualization of multi-modality registered data sets in a single automated combined examination, thereby facilitating improved methods for localization and characterization of suspicious regions in breast images, thereby resulting in a reduction in unnecessary biopsies and a greater efficiency in breast scanning.

Since clinical ultrasound, and 3D, as well as 2D, digital X-rays are available in co-registered format using system 12, system 12 therefore provides a platform for additional advanced applications, such as, but not limited to, a multi-modality computer-aided diagnosis (CAD) algorithm or improved classification schemes for CAD. System 12 facilitates navigating breast biopsies with greater accuracy than available with 2D X-ray data sets because of the information in the depth dimension. Patients undergoing various forms of treatment for breast cancer may be monitored with system 12 to evaluate their response to therapy because of the automation of ultrasound scanning and therefore the reduced effect of variability in scanning. For example, using system 12, an X-ray and ultrasound image dataset may be acquired during an initial examination and a plurality of subsequent examinations occurring over various time intervals during treatment. During a subsequent examination, the patient may be positioned in a manner similar as positioned in the initial examination by using system 12 to image breast 23 ultrasonically with the same operating parameters as used when acquiring the first data set. Mutual information or feature based registration techniques may then be used to determine the x, y, and z displacements needed in iterative patient repositioning required to bring the two sets of ultrasound data into better registration with one another using clearly identifiable features on both data sets or other means. Such features could also be potentially implanted if surgical treatment is being used. This could provide the clinicians with data sets that are substantially registered with respect to each other since recurrent cancers are not uncommon, therefore system 12 may be used to track progress and modify the treatment regimen accordingly. Further, system 12 facilitates a reduced compression of breast 23 because of the mitigation of structured noise that is a major motivational factor for increased compression. Modifications to system 12 may also be made to enable the combination of stereo-mammography with 3D ultrasound.

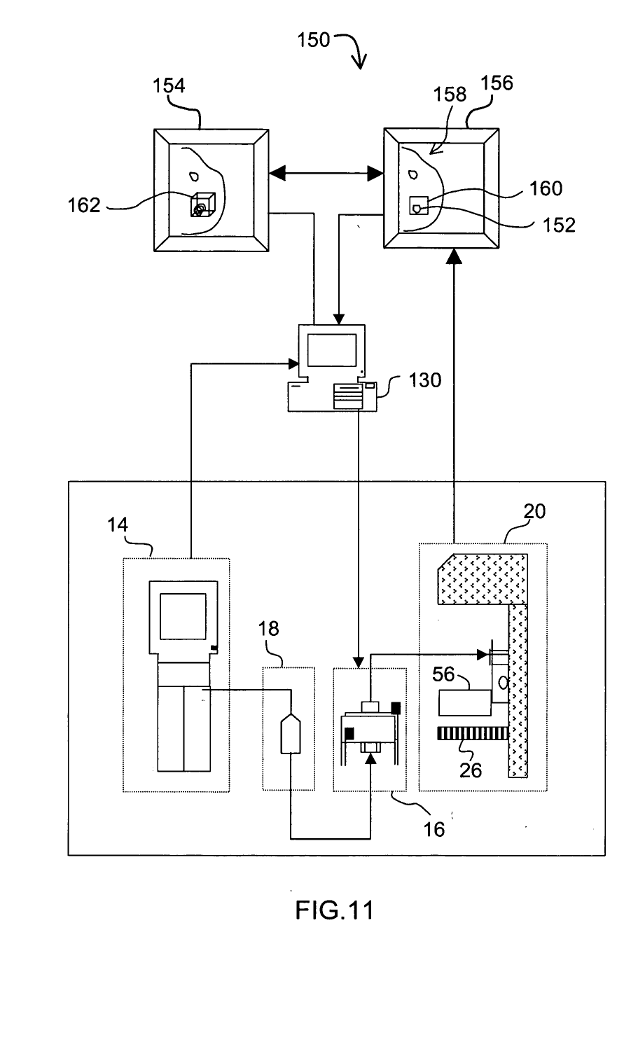

FIG. 11 is an embodiment of a system 150 for viewing an abnormality 152 in different kinds of images. System 150 includes ultrasound imaging system 14, ultrasound probe 18, probe mover assembly 16, imaging system 20, central computer 130, and workstations 154 and 156. Each of workstation 154 and 156 is programmed to perform functions described herein, and as used herein, the term workstation is not limited to just those integrated circuits referred to in the art as computers, but broadly refers to computers, controllers, processors, microcontrollers, microcomputers, programmable logic controllers, application specific integrated circuits, and other programmable circuits, and these terms are used interchangeably herein. The patient is positioned so that breast 23 covered with an acoustic couplant, such as, for instance, oil, is compressed and placed on imaging system 20 between compression paddle 56 and detector 26. X-rays are transmitted through breast 23 to obtain an X-ray image 158, which is displayed on workstation 156. It is noted that X-ray image 158 of abnormality 152 can be displayed on any display device, such as a display device of ultrasound imaging system 14, display 54, a display device of central computer 130, or a display device of workstation 154. Moreover, X-ray image 158 can be a projection image or an image acquired using the tomosynthesis acquisitions described above.

A user, such as a radiologist or a technologist, marks a region of interest (ROI) 160 on X-ray image 158 to encompass an abnormality, such as a nodule, appearing suspicious to the user. Examples of shapes of ROI 160 include a rectangle, a square, a circle, an oval, and a polygon. In an alternative embodiment, a CAD algorithm marks ROI 160 to encompass abnormality by using a thresholding method. In the thresholding method, if intensities or CT Hounsfield numbers of pixels displaying X-ray image 158 are at or above a threshold, the pixels are designated as pixels corresponding to ROI 160. If intensities of pixels displaying X-ray image 158 are below the threshold, the pixels are designated as pixels corresponding to regions outside ROI 160. The pixels corresponding to ROI 160 have different intensities since X-rays that pass through abnormality 152 have a different amount of attenuation than X-rays that pass through the remaining regions of breast 23. In yet another alternative embodiment, any variety of known 2D algorithms described in U.S. Pat. No. 5,133,020 or in U.S. Pat. No. 5,491,627 are used. Coordinates of ROI are fed back through an interface between workstation 156 and central computer 130.

To obtain ultrasound images, probe mover assembly 16 is attached to imaging system 20 as described above, with probe 18 engaged in receptacle 100 of probe mover assembly 16. The acoustic sheath or coupling gel 120 is applied on compression paddle 56 as shown in FIG. 8. Co-ordinates of ROI 160 are transferred by central computer 130 to a probe mover software that instructs ultrasound probe 18 to relocate to the position on compression paddle 56 that corresponds spatially to the coordinates and an ultrasound scan is performed using ultrasound imaging system 14 with a selection of ultrasound parameters. In one embodiment, ROI 160 that is defined by the coordinates and no other region of breast 23 is scanned using ultrasound imaging system 14. In an alternative embodiment, any portion, such as breast 23, of the patient is scanned using ultrasound imaging system 14.

Ultrasound images of abnormality 152 that are obtained after scanning ROI 160 are returned via central computer 130 from a cine memory or hard drive of ultrasound imaging system 14 to be displayed on workstation 154. It is noted that the ultrasound images of abnormality 152 can be displayed on any display device, such as a display device of ultrasound imaging system 14, display 54, a display device of central computer 130, or a display device of workstation 156. In an embodiment, the ultrasound images are displayed in an ROI 162 one at a time in a cine loop. Examples of shapes of ROI 162 include 3D shapes such as cubical, spherical or ellipsoidal shapes. In another embodiment, X-ray image 158 on workstation 156 is also shown on workstation 154 for a comparison between X-ray image 158 and the ultrasound images. In another embodiment, the ultrasound images of abnormality 152 are superimposed over X-ray image 158 and displayed on workstation 154. In yet another alternative embodiment, the ultrasound images are displayed on workstation 154 and X-ray image 158 is displayed on workstation 156, and both workstations 154 and 156 are placed side-by-side to compare the ultrasound images with X-ray image 158. It is noted that several regions of interest, such as ROI 160, can be chosen on X-ray image 158. Data sets corresponding to the regions of interest can be stored for evaluation at a later time or displayed in real-time while the patient is positioned and the user is present in an examination room.

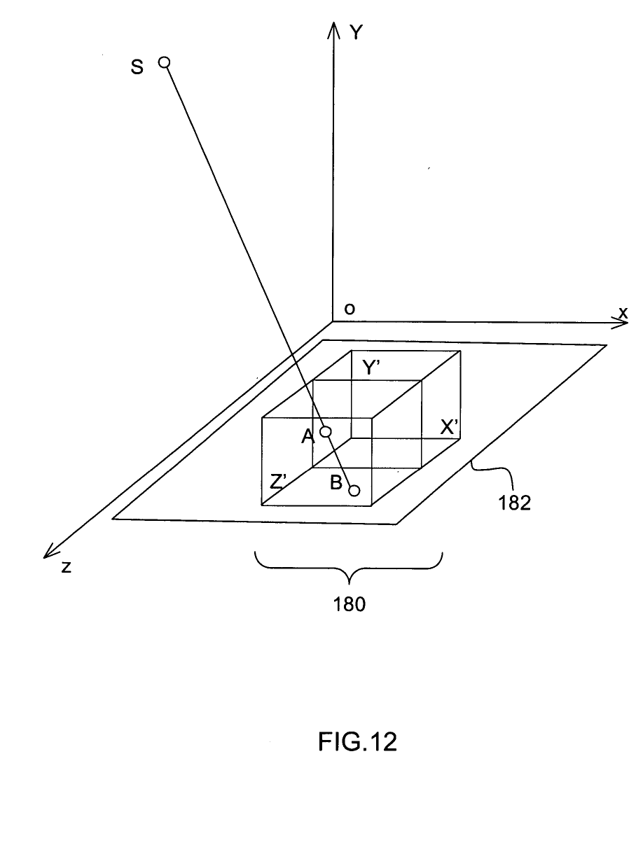

FIG. 12 shows an XYZ and an X′Y′Z′ coordinate system to illustrate a method for viewing an abnormality in different kinds of images. The method includes registering volumetric 3D data, such as data in an ultrasound volume 180 acquired using ultrasound imaging system 14, relative to 2D image data, such as data acquired using imaging system 20, on a plane 182. Data of ultrasound volume 180 is acquired with a uniform motion of ultrasound probe 18 in the direction of Z-axis shown in FIG. 12. Ultrasound probe 18 moves in a direction parallel to one edge of plane 182 with the face of ultrasound probe 18 parallel to plane 182 to acquire the data of ultrasound volume 180. Other examples of the volumetric 3D data include data acquired using magnetic resonance imaging (MRI) systems, computed tomography (CT) systems, positron emission tomography (PET) systems and X-ray imaging systems. Other examples of the 2D image data include data acquired using MRI systems, CT systems, PET systems, and ultrasound imaging systems.

XYZ is a coordinate system of plane 182 of a 2D X-ray image obtained using imaging system 14. O is the origin of the XYZ coordinate system and Y=0 is plane 182 of the 2D X-ray image. In an alternative embodiment, Y=n is a plane of the 2D X-ray image, where n is a real number. Radiation source 24, such as an X-ray source, is positioned at point S=(q₁,q₂,q₃) in the XYZ coordinate system. X′Y′Z′ is a local coordinate system of ultrasound volume 180 obtained by scanning the patient using ultrasound imaging system 20.

If A is a point in ultrasound volume 180 with coordinates (x₁u₁,y₁u₁,z₁u₁) then A has coordinates (x₁,y₁,z₁) in the XYZ coordinate system, where
xᵢ=c₁x₁u₁+t₁, (1)
y₁=c₂y₁u₁+t₂, (2)
z₁=c₃z₁u₁+t₃, (3)
where scaling c₃ is unknown, translations t₁, t₂, and t₃ are unknown, c₁ is a length of pixels in a direction along an X-axis, shown in FIG. 12, of the XYZ coordinate system, c₂ is a length of pixels in a direction along a Y-axis, shown in FIG. 12, of the XYZ coordinate system, and c₃ represents a distance between consecutive slices in ultrasound volume 180. The pixels having length c₁ in a direction along the X-axis and a length c₂ along the Y-axis are pixels on a plane of an ultrasound image of ultrasound volume 180.

Point B is a projection of point A on to plane Y=0 from the center of projection S. From colinearity of points, S, A, and B, B−S=r₁(A−S), in coordinate form, is
x₁x₁−q₁=r₁(c₁x₁u₁+t₁−q₁), (4)
y₁x₁−q₂=r₁(c₂y₁u₁+t₂−q₂), (5)
z₁x₁−q₃=r₁(c₃z₁u₁+t₃−q₃), (6)
where r₁ is an unknown real number and (x₁x₁,y₁x₁,z₁x₁) are coordinates of point B in the XYZ coordinate system. y₁x₁=0 since point B lies on plane Y=0. However, Y is not equal to zero if point B lies on any other plane besides Y=0.

The system of equations 4, 5, and 6 is undetermined since there are five unknown variables and three equations 4, 5, and 6. If another pair of matching points C and D is added, three more equations are obtained, one unknown real number r₂ will be added, and c₃, t₁, t₂, and t₃ will remain the same. C is a point in ultrasound volume 180. Point D is a projection of point C onto plane Y=0 from the center of projection S. Therefore, scaling C₃, and translations t₁, t₂, and t₃ can be found by adding three more equations. Scaling c₃, translations t₁, t₂, and t₃, c₁, and c₂ define registration of ultrasound volume 180 relative to XYZ coordinate system, which is also an X-ray coordinate system. The three additional equations are
x₂x₂−q₁=r₂(c₁x₂u₂+t₁−q₁), (7)
y₂x₂−q₂=r₂(c₂y₂u₂+t₂−q₂), (8)
z₂x₂−q₃=r₂(c₃z₂u₂+t₃−q₃), (9)
where (x₂u₂,y₂u₂,z₂u₂) are coordinates of point C in the X′Y′Z′ coordinate system, (x₂,y₂,z₂) are coordinates of point C in the XYZ coordinate system,
x₂=c₁x₂u₂+t₁, (10)
y₂=c₂y₂u₂+t₂, (11)
z₂=c₃z₂u₂+t₃, (12)

From colinearity of points S, C, and D, D−S=r₂(C−S), is written, in coordinate form, as equations 7, 8, and 9 shown above.

The system of six equations 4, 5, 6, 7, 8, and 9 relative to r₁, r₂, c₃, t₁, t₂, and t₃ is non-linear, where r₁ is for one pair of matching points A and B and r₂ is for another pair of matching points C and D. A linear system can be obtained by expressing r₁ from one of the three equations 4, 5, and 6, and substituting the resulting expression into the other two equations and by expressing r₂ from one of the three equations 7, 8, and 9, and substituting the resulting expression into the other two equations.

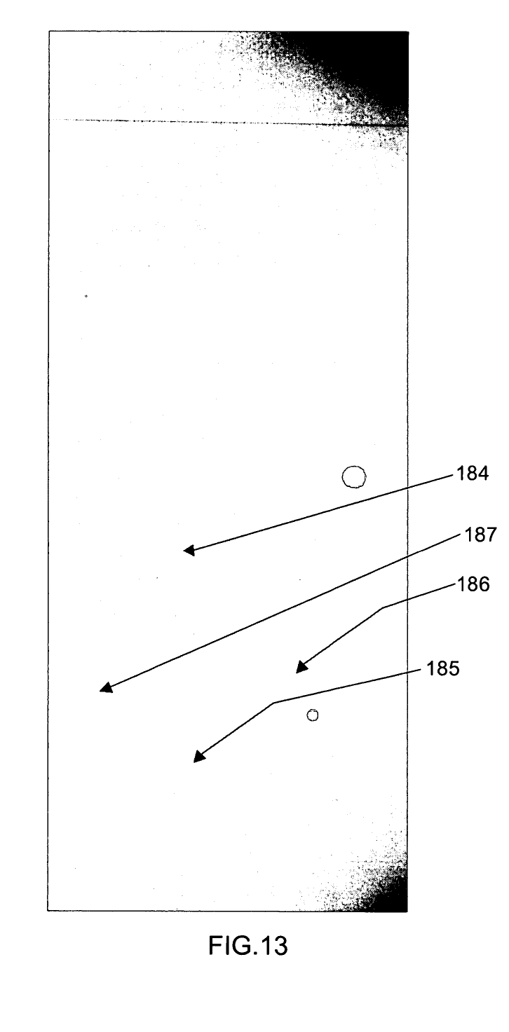

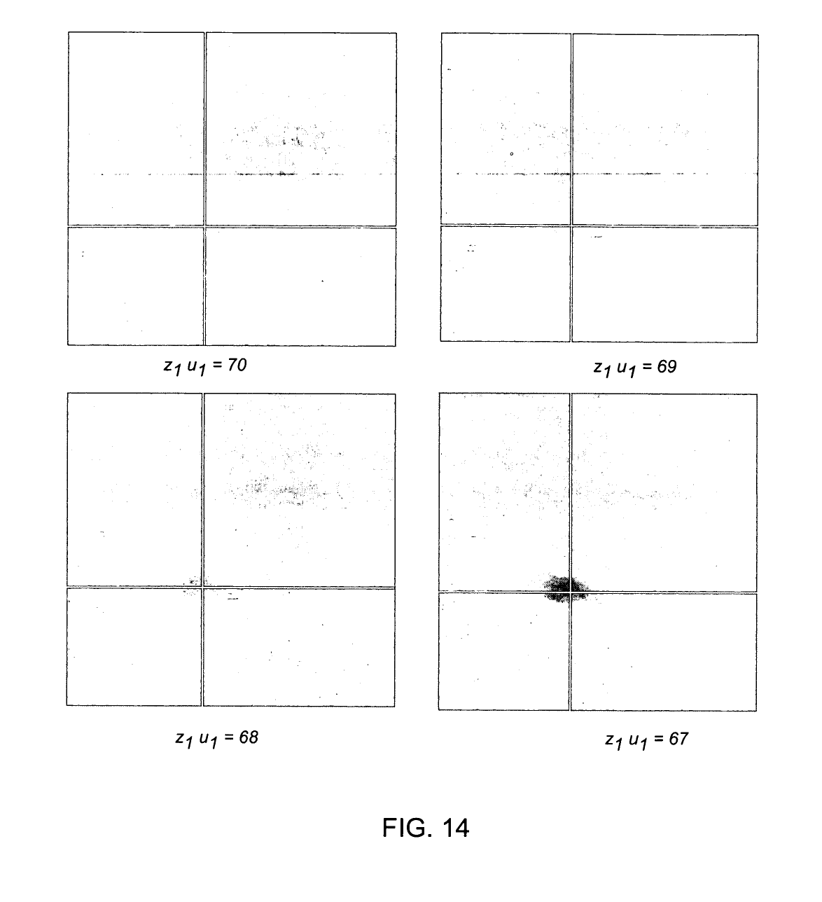

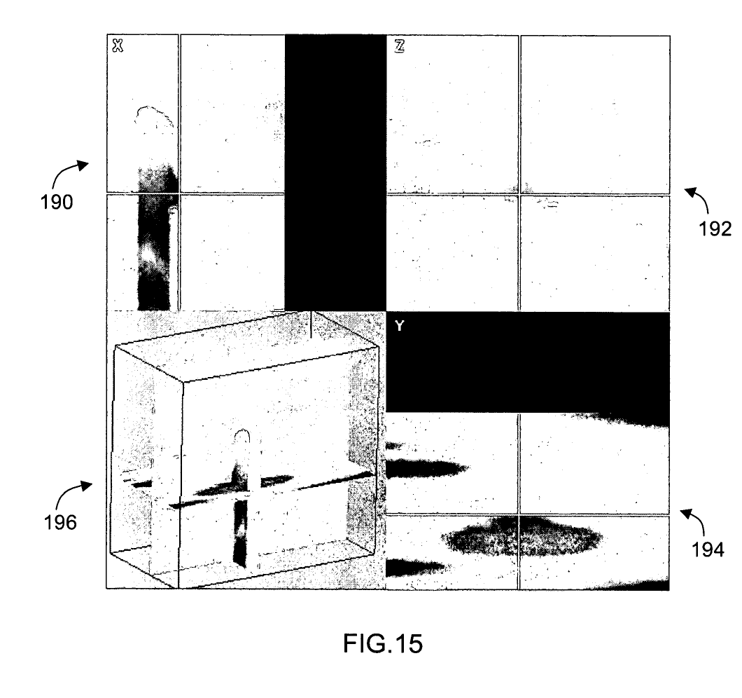

FIGS. 13 and 14 show X-ray images acquired using imaging system 14 and FIG. 15 shows ultrasound images 190, 192, 194, and 196 to illustrate an embodiment of a method for viewing an abnormality in different kinds of images. The method includes selecting matching points, such as matching points, A and B, or matching points C and D.

Matching points, such as points A and B, are selected as follows. A 3D feature of ultrasound volume 180 projects on to a 2D feature, such as a round shaped feature, of a 2D X-ray image in a 2D plane. To find matching points on the boundaries of the 2D and 3D features, four extreme points 184, 185, 186, and 187 on the boundary of the 2D feature in the 2D X-ray image are identified. Alternatively, a higher or a lower number of extreme points than four extreme points are identified.

Moreover, 2D slices of ultrasound volume 180 that are orthogonal to plane y₁u₁=0, such as, for example, slices for which x₁u₁=U or z₁u₁=V are identified. Alternatively, 2D slices of ultrasound volume 180 that are orthogonal to plane y₁u₁=m, where m is a real number, are identified. By decreasing the value of V as shown in FIG. 14, a value at which the slice z₁u₁=V shows part of the 2D feature for a first time is identified. When the slice z₁u₁=V shows part of the 2D feature for the first time, a first matching pair of points is obtained. An example of a point having coordinates (x₁u₁,y₁u₁,z₁u₁)=(119,107,69) that matches extreme point 184 is shown in ultrasound images 190, 192, and 194 in FIG. 15. By going in the opposite direction by starting at a lower value of V, a second pair of matching points is obtained, where one of the second pair of matching points is extreme point 185. A point matching extreme point 186 and a point matching extreme point 187 is found by manipulating slice x₁u₁=U in a similar manner in which slice z₁u₁=V is manipulated.

By finding more than two pairs of matching points, average values for c₃, t₁, t₂, and t₃ can be computed to reduce any registration errors. For example, c₃, t₁, t₂, and t₃ are obtained from pairs of matching points A and B and matching points C and D. In the example, c₄, t₅, t₆, and t₇ are obtained from other pairs of matching points, such as, a pair of matching points E and F and a pair of matching points G and H. c₃ and c₄ can be averaged to obtain c₅. The selection of matching points is manual or automatic. The automatic selection is executed by central computer 130, ultrasound imaging system 20, or computer 48. The automatic selection of matching points is described as methods for automatic feature detection and feature matching algorithms in J. B. Antoine Maintz and Max A. Viergever, An Overview of Medical Image Registration Methods, Medical Image Analysis (1998), v. 2, n. 1, pp. 1-37 and in Isaac N. Nankenman Handbook of Medical Imaging Processing and Analysis (2000)

Hence, a technical effect of the systems and methods for viewing an abnormality in different kinds of images is that abnormality 152 on X-ray image 158 can be viewed more closely in 3D by using probe mover assembly 16 to scan ultrasound probe 18 in an ROI encompassing abnormality 152. Moreover, another technical effect of the systems and methods for viewing an abnormality in different kinds of images is to semi-automatically image in real-time any suspicious regions identified in a mammogram with co-registered ultrasound scanning within a few minutes or less of the mammogram, with the patient positioned in the same way. Yet another technical effect of the systems and methods is to allow a radiologist to analyze simultaneously an area of interest in X-ray image data and its corresponding volume of interest in 3D ultrasound data. It is noted that the herein described systems and methods can be used for biopsy guidance and in nuclear medicine. Moreover, the herein described systems and methods can be used in other imaging modalities, such as, magnetic resonance imaging (MRI) systems. Additionally, the herein described systems and methods can be applied in nondestruction imaging, such as, identifying fractures or cracks. Furthermore, ultrasound imaging system 14 and tomosynthesis imaging system 20 can be provided by different vendors.

While the invention has been described in terms of various specific embodiments, those skilled in the art will recognize that the invention can be practiced with modification within the spirit and scope of the claims.

1. A method for viewing an abnormality in different kinds of images, said method comprising:
scanning an object using a first imaging system to obtain at least a first image of the object;
determining coordinates of a region of interest (ROI) visible on the first image, wherein the ROI includes the abnormality; and
using the coordinates of the ROI to scan the object with a second imaging system.

2. A method in accordance with claim 1 wherein determining coordinates of the ROI visible on the first image comprises manually marking the ROI on a display device that displays the first image.

3. A method in accordance with claim 1 wherein determining coordinates of the ROI visible on the first image comprises automatically marking the ROI by using a computer-aided design (CAD) algorithm.

4. A method in accordance with claim 1 wherein using the coordinates of the ROI to scan the object with a second imaging system comprises:
instructing a probe mover to move a probe to the co-ordinates to scan a specific region of the object, wherein the specific region is defined by the coordinates; and
scanning the specific region of the object with the second imaging system to obtain at least one second image.

5. A method in accordance with claim 4 further comprising displaying the first and the second images concurrently to enable a user to view the abnormality.

6. A method in accordance with claim 1 further comprising registering 2-dimensional (2D) data from which the first image is generated with 3-dimensional (3D) data obtained by scanning the object with the second imaging system.

7. A method in accordance with claim 6 wherein registering 2D data from which the first image is generated with 3D data comprises:
obtaining at least six equations having at least six unknowns, wherein each equation establishes a relationship between coordinates of 2D data acquired from the first imaging system and coordinates of 3D data acquired from the second imaging system; and
solving the six equations to obtain the six unknowns.

8. A system for viewing an abnormality in different kinds of images, said system comprising:
an X-ray imaging system configured to scan an object to obtain at least one X-ray image of the object; and
a controller configured to:
determine coordinates of a region of interest (ROI) visible on the first image, the ROI including the abnormality; and
utilize the coordinates of the ROI to scan the object with an ultrasound imaging system.

9. A system in accordance with claim 8 wherein to determine coordinates of the ROI visible on the X-ray image the controller is configured to enable manual marking of the ROI on a display device that displays the first image.

10. A system in accordance with claim 8 wherein to determine coordinates of the ROI visible on the X-ray image the controller is configured to mark the ROI by using a computer-aided design (CAD) algorithm.

11. A system in accordance with claim 8 wherein to utilize the coordinates of the ROI to scan the object with the ultrasound imaging system the controller is configured to:
instruct a probe mover to move a probe to the co-ordinates to scan a specific region of the object, wherein the specific region is defined by the coordinates; and
instruct the ultrasound imaging system to scan the specific region of the object to obtain at least one ultrasound image.

12. A method for viewing an abnormality in different kinds of images, said method comprising:
registering 3-dimensional (3D) data relative to 2-dimensional (2D) data, wherein the 3D data is obtained using an imaging system that is different than an imaging system used to obtain the 2D data.

13. A method in accordance with claim 12 wherein registering 3D data relative to 2D data comprises registering 3D data relative to 2D data without using fiducial marks on a patient having the abnormality.

14. A method in accordance with claim 12 wherein registering 3D data relative to 2D data comprises registering 3D data acquired using an ultrasound imaging system relative to 2D data acquired using an X-ray imaging system.

15. A method in accordance with claim 14 further comprising establishing a relationship between the 3D data acquired using the ultrasound imaging system and the 2D data acquired using the X-ray imaging system.

16. A method in accordance with claim 12 wherein registering 3D data relative to 2D data comprises:
obtaining at least six equations having at least six unknowns, wherein each equation establishes a relationship between coordinates of 2D data acquired from an X-ray imaging system and coordinates of 3D data acquired from an ultrasound imaging system; and
solving the six equations to obtain the six unknowns.

17. A method in accordance with claim 16 wherein three of the six equations are x₁x₁−q₁=r₁(c₁x₁u₁+t₁−q₁), y₁x₁−q₂=r₁(c₂y₁u₁+t₂−q₂), and z₁x₁−q₃=r₁(c₃z₁u₁+t₃−q₃), wherein (x₁,y₁,z₁) are coordinates in a first coordinate system of a first datum acquired using the ultrasound imaging system, (x₁u₁,y₁u₁,z₁u₁) are coordinates in a second coordinate system of the first datum, (q₁,q₂,q₃) are coordinates of a center of projection S at which an X-ray source of the X-ray imaging system is positioned to project the first datum on to a plane from the center of projection, r₁, c₃, t₁, t₂, and t₃ are five of the six unknowns, c₁ is a length in an along an X-axis of a pixel of a 2D image generated from data acquired using the ultrasound imaging system, and c₂ is a length in an along a Y-axis of the pixel of the 2D image generated from data acquired using the ultrasound imaging system.

18. A method in accordance with claim 17 further comprising:
selecting the first datum and its projection on to the plane by:
viewing an extreme point at a boundary of a feature within an X-ray image generated using the X-ray imaging system;
viewing a 2D slice of data obtained using the ultrasound imaging system, wherein the 2D slice is orthogonal to a plane of the X-ray image; and
relocating the 2D slice to visualize the object for a first time in the 2D slice, wherein the extreme point is the projection of the first datum.

19. A method in accordance with claim 17 wherein the remaining three of the six equations are x₂x₂−q₁=r₂(c₁x₂u₂+t₁−q₁), y₂x₂−q₂=r₂(c₂y₂u₂+t₂−q₂), and z₂x₂−q₃=r₂(c₃z₂u₂+t₃−q₃), wherein (x₂,y₂,z₂) are coordinates in the first coordinate system of a second datum acquired using the ultrasound imaging system, (x₂u₂,y₂u₂,z₂u₂) are coordinates in the second coordinate system of the second datum, and r₂ is the sixth unknown.

20. A method in accordance with claim 16 further comprising:
obtaining six additional equations having six additional unknowns, wherein each of the six additional equations establishes a relationship between coordinates of 2D data acquired from the X-ray imaging system and coordinates of 3D data acquired from the ultrasound imaging system;
solving the six additional equations to obtain the six additional unknowns; and
averaging a first unknown of the six unknowns with a corresponding first additional unknown of the six additional unknowns.

21. A method for viewing an abnormality in different kinds of images, said method comprising:
scanning an object using an X-ray imaging system to obtain at least one X-ray image of the object;
determining coordinates of a region of interest (ROI) on the X-ray image, wherein the ROI includes the abnormality;
instructing a probe mover to move a probe to the co-ordinates to scan a specific region of the object, wherein the specific region is defined by the coordinates; and
instructing an ultrasound imaging system to scan the specific region of the object to obtain at least one ultrasound image.

22. A method in accordance with claim 21 wherein determining coordinates of the ROI on the X-ray image comprises manually marking the ROI on a display device that displays the X-ray image.

23. A method in accordance with claim 21 wherein determining coordinates of the ROI on the X-ray image comprises automatically marking the ROI by using a computer-aided design (CAD) algorithm.

24. A system for viewing an abnormality in different kinds of images, said system comprising:
an X-ray imaging system configured to scan an object to obtain at least one X-ray image of the object; and
a controller configured to:
determine coordinates of a region of interest (ROI) visible on the X-ray image, the ROI including the abnormality;
utilize the coordinates of the ROI to scan the object with an ultrasound imaging system; and
register 2-dimensional (2D) data from which the X-ray image is generated with 3-dimensional (3D) data obtained by scanning the object with the ultrasound imaging system.

25. A system in accordance with claim 24 wherein to utilize the coordinates of the ROI to scan the object with the ultrasound imaging system the controller is configured to:
instruct a probe mover to move a probe to the co-ordinates to scan a specific region of the object, wherein the specific region is defined by the coordinates; and
instruct the ultrasound imaging system to scan the specific region of the object to obtain at least one ultrasound image.

26. A system in accordance with claim 24 wherein to register 2D data from which the X-ray image is generated with 3D data the controller is configured to:
obtain at least six equations having at least six unknowns, wherein each equation establishes a relationship between coordinates of the 2D data acquired from the X-ray imaging system and coordinates of the 3D data acquired from the ultrasound imaging system; and
solve the six equations to obtain the six unknowns.
